(19) United States
(12) Patent Application Publication
(10) Pub. No.: US 2008/0289587 A1
(43) Pub. Date: Nov. 27, 2008

(54) Dog training collar

(76) Inventors: Ilusion Millan, Burbank, CA (US); Cesar Millan, Burbank, CA (US); Jacqueline M. Rohr, Burbank, CA (US)

Correspondence Address: MARC E. HANKIN, ESQ., 11414 THURSTON CIRCLE, LOS ANGELES, CA, 90049, US

(21) Appl. No.: 12/154,086

(22) Filed: May 19, 2008

Related U.S. Application Data
(63) Continuation-in-part of application No. 11/408,379, filed on Apr. 21, 2006, now abandoned.

(51) Int. Cl. A01K 27/00

(52) U.S. Cl. 119/864

(57) ABSTRACT

The present invention is directed to a dog training collar that is comprised of at least three collars, where at least one of the collars is a slip collar, and a plurality of perpendicular elements running perpendicular to the collars, which are also connected and link to the collars.

### CROSS-REFERENCE WITH RELATED APPLICATIONS

This is a continuation-in-part of co-pending application Ser. No. 11/408,379, filed Apr. 21, 2006.

### FIELD OF INVENTION

This invention relates generally to the field of dog training collars.

### BACKGROUND

Dog owners find themselves faced with pet restraint issues, including a frequent need to restrain and maintain physical control of the pet during training, dog walking and other activities. Dogs are commonly restrained by way of attaching a leash to a flat collar, choke chain, slip, limited slip, or prong type collar that encircles the animal's neck. While these collars are currently widely used for restraining pets, they have not proven to be entirely satisfactory. These devices typically result in pressure on the animal's neck and airway, and cause choking, or pinching when the animal is attached to a leash.

Various improvements on the collar have been disclosed to address some of these limitations. For example, U.S. Pat. No. 5,129,363 to Ricketts discloses a leash apparatus having an elongated body with an actuator rod. A handle is fitted on one end and a strap on the other. The strap forms an adjustable noose to secure an animal. The device assists those of diminished physical capability to secure the strap about the animal's head.

U.S. Pat. No. 5,690,059 to Woods discloses a slip-type apparatus that has two collars and perpendicular elements connected to them, where at least one of the collars acts as a slip collar. However, because at least one of the collars is used as a slip collar, the entire apparatus does not remain stably secure to the dog's neck when force is applied with a leash. Thus, Woods lacks the structural limitations recited in the claims which enable the synergistic effect of precisely, accurately, and comfortably securing the collars in proper position. Moreover, because only standard shank holes spaced one inch apart are present on the collar, only one inch increments can be made, which results in a less than ideal fit for the dog.

In light of the foregoing, a need still exists for a collar that allows a dog owner to control his/her pet during training, walking, and other activities while maintaining maximum comfort for the pet.

### SUMMARY OF THE INVENTION

This invention is directed towards overcoming the above shortcomings by disclosing an apparatus that fits comfortably and precisely around the neck of the animal for restraint and training purposes, but is yet comfortable and simple to put on, and take off.

In one embodiment, the apparatus in accord with the invention is comprised of at least three collars, wherein at least one of said collars is a slip collar, with a plurality of perpendicular elements, running perpendicular to said collars, which are connected and link to said collars.

In an alternative embodiment, the apparatus in accord with the invention is comprised of perpendicular elements connected to one another by an optionally resilient fabric. Alternatively, the perpendicular elements are connected to one another by optionally mesh netting. The resilient fabric, or mesh netting, may easily be removed, if desired. The mesh netting may be attached to the perpendicular elements and collars by a folded flap, made of fabric or netting, which loops around said perpendicular elements and collars.

In yet another embodiment, the apparatus in accord with the invention is comprised of at least three collars, wherein at least one of said collars is a slip collar, with more than three perpendicular elements, running perpendicular to said collars, which are connected and link to said collars, wherein at least one of said perpendicular elements is adjustably connected to said collars, wherein at least one of said collars is made of core-wound cord, wherein the other collars are not made of core-wound cord, each having a snap-on buckle.

In a further construction, the apparatus in accord with the invention is comprised of at least three collars, wherein at least one of said collars is a slip collar, with three perpendicular elements, running perpendicular to said collars, which are connected and link to said collars, wherein two of the three perpendicular elements is adjustably connected to said collars, wherein at least one of the three collars is made of core-wound cord, and wherein the other two collars are not made of core-wound cord, each having a snap-on buckle.

In another form, the apparatus in accord with the invention is comprised of at least three collars, wherein at least one of said collars is a slip collar, with a plurality of perpendicular elements, running perpendicular to said collars, which are connected and link to said collars. Said slip collar is adjusted by way of two or three “O” rings.

An advantage of the present invention is that the apparatus is able to support the use of a slip collar around the neck of the dog without harming the dog.

A further advantage of the present invention is that the slip collar is held in the ideal position by the non-slip collars for maximum control of the dog.

An advantage of the present invention is that the buckles on the collars provide greater accuracy of fit of these collars on the dog by allowing much greater adjustments for sizing fit.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 is a side view of the collar.

FIG. 2 is a perspective view of the collar around the neck of the animal, shown with the removable resilient fabric or mesh netting.

FIG. 3 is a view of the collar from above the animal's neck, shown with the removable resilient fabric or mesh netting.

FIG. 4 is a view of the collar from beneath the animal's neck, shown with the removable resilient fabric or mesh netting.

FIG. 5 is a top view of the collar, shown with more than 2 “O” rings.

FIG. 6 is a top view of the collar, shown with the slip collar not engaged to the perpendicular elements of the collar.

FIG. 7 is a view of the collar in FIG. 6 from below the animal's neck.

FIG. 8 is a top view of the collar, shown with one perpendicular element on top.

FIG. 9 is a top view of the collar, shown in an alternate embodiment wherein both of the slip collar's ends are attached to one “O” ring.

FIG. 10 is a top view of the collar, shown in the Martingale style with a third “O” ring.

### DRAWINGS—REFERENCE NUMERALS

| | |
|---|---|
| 10 | One embodiment of the invention |
| 11 | First non-slip collar |
| 12 | Second non-slip collar |
| 13 | Slip collar |
| 14 | First perpendicular element |
| 15 | Second perpendicular element |
| 16 | Third perpendicular element |
| 17 | Adjustable element |
| 18 | Adjustable element |
| 19 | First connector element |
| 20 | Second connector element |
| 21 | O-ring |
| 22 | O-ring |
| 22.1 | O-ring |
| 23 | Keeper |
| 24 | Keeper |
| 26 | Distal end of perpendicular 14 |
| 27 | Distal end of perpendicular 16 |
| 28 | Proximate end of perpendicular 14 |
| 29 | Proximate end of perpendicular 16 |
| 30 | Distal end of perpendicular 15 |
| 31 | Proximate end of perpendicular 15 |
| 32 | Looped element |
| 33 | Looped element |
| 34 | Looped element |
| 35 | Looped element |
| 36 | Affixed element |
| 37 | Affixed element |
| 38 | Leash |
| 39 | Mesh netting/resilient fabric |
| 40 | Mesh netting/resilient fabric flap |

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of the embodiments of the invention.

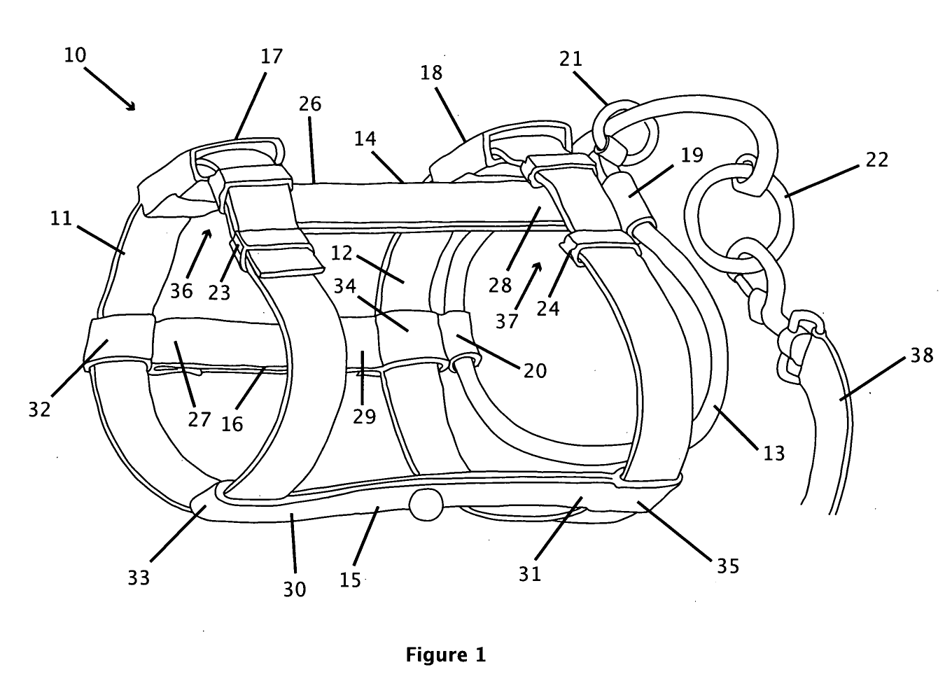

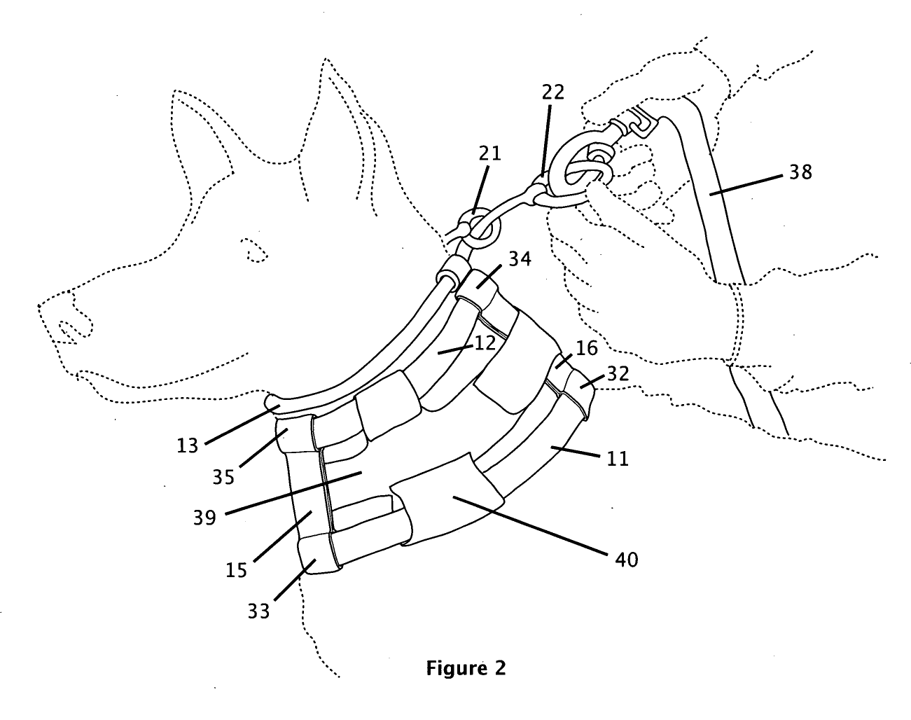

Turning now to the figures in which one presently preferred embodiment of the invention appears, FIG. 1 shows a side view of the collar 10. The invention as described is able to maintain a comfortable precise fit on the neck of the dog.

FIG. 1 shows that the invention can have six components that together form a web-like structure, comprising of a first flat collar 11, a second flat collar 12, and a third, rounded slip collar 13. The first 11 and second 12 collars (hereinafter are referred to as “non-slip collars”) are connected together via perpendicular elements 14, 15 and 16 that run perpendicular to the collars 11, 12 and 13. As illustrated, the perpendicular elements 14, 15, and 16 are constructed to be self-layering and self-stiffening, connecting the collars and acting as built-in self-spacers to provide optimal positioning and use of the collars. The distal end of perpendicular element 14 is permanently secured to non-slip collars 11 and 12 at its distal 26, and proximate 28 ends. In contrast, the distal (30 and 27) and proximal (31 and 29) ends of perpendicular 15 and 16 are adjustably connected to non-slip collars 11 and 12. Thus, perpendicular elements 15 and 16 can later be adjusted by the pet owner to comfortably and precisely fit the pet. The perpendicular elements 14, 15, and 16 are constructed to provide ends via self-looping, as illustrated in FIG. 1. For example, perpendicular element 16 is illustrated having a stitched self-folding, self-layering, self-stiffening configuration such that the perpendicular element 16 is semi-rigid, flexible, and layers back on itself to form connector element 20 and looped elements 32 and 34. Accordingly, it is not necessary to include a separate internal or external stiffener. Although this embodiment shows perpendicular elements 15 and 16 adjustably connected, and perpendicular element 14 permanently secured to the collars, it is understood that in alternative embodiments either the distal, and/or proximal ends of the any of the perpendicular elements, or any combinations thereof could be permanently or adjustably connected. Methods to permanently secure, or to adjustably connect these perpendicular elements to the collars are well known to those of ordinary skill in the art at this time. In this embodiment stitching at positions 36 and 37 is used to permanently secure these elements to non-slip collars 11 and 12, while looped elements 32, 33, 34 and 35 allow perpendicular elements 15 and 16 to be adjusted on non-slip collars 11 and 12, respectively. For example, positions 36 and 37 each can be formed by a flat open loop, which is terminated on either side of the loop by tacking or stitching to allow the non-slip collars 11 and 12 to pass through. Then the loop can be tacked or stitched down permanently to anchor the perpendicular element 14 to the non-slip collars 11 and 12.

It should be understood that although the web-like structure as shown in this embodiment is comprised of three separate and individual perpendicular elements, in an alternative embodiment there could be more than three perpendicular elements, or actual fabric or meshing connecting each perpendicular element to one another. Moreover, there could be more than three collars used but at least one of these collars should act as a slip collar 13. An unexpected benefit of adopting at least two non-slip collars is that the slip collar is held in position at the top of the neck and just behind the ears of the dog by the additional non-slip collars. Dogs respond best to corrective control when the slip collar is held in this position, because the slip collar is not allowed to travel down the dog's neck, where the trainer has less control due to the dog's musculature.

At the proximate end of perpendicular elements 14 and 16 is found first 19 and second connector 20 elements, enclosing slip collar 13. The first 19 and second connector 20 elements of the illustrated embodiments are constructed from a self-formed loop, formed by folding the material of the perpendicular elements 14 and 16 and tacking it to terminate the loop. The slip collar 13 can thereby movably pass through the first 19 and second connector 20 elements. Slip collar 13 has also two metal rings 21 and 22 attached to each end of the slip collar 13. Ring 22 is shown here as an “O” ring having a diameter of 1 inch, whereas ring 21 is shown here as an “O” ring with a diameter of about ¾ inch. It should be appreciated that “D” rings could be used instead of the “O” rings as shown and described, and that different sizes could be used. The absolute sizes of the rings are not important, and one size or shape could easily be substituted for another.

The combination of connector elements 19 and 20, with the two “O” rings 21 and 22, allow slip collar 13 to immediately be tightened, or loosened, when the end of the collar is pulled or released, respectively, with the leash. Slip collar 13 represents the only collar in this embodiment that can perform in this manner. There is no mechanism to define a maximum extent to which the slip collar 13 can be tightened; nor is there a mechanism to restrict the maximum loosening of slip collar 13 around the dog's neck, other than the length of the slip collar 13 and the two “O” rings 21 and 22 which cooperate to prevent the slip collar 13 from coming undone.

Non-slip collar 12 will rest on the pet's neck just behind slip collar 13 and has an adjustable element, which in this embodiment is a conventional snap-on buckle 18 that is used to adjust and fix the diameter of non-slip collar 12. Non-slip collar 11 will sit at the base of the neck of the pet, and has an adjustable element, which in this embodiment is a conventional snap-on buckle 17 used to adjust and fix the diameter of non-slip collar 11. Slip collar 13 hangs loosely around the neck of the animal above non-slip collar 12, but below the ears of the dog. As illustrated, the perpendicular element 15 does not engage the slip collar 13, which allows the slip collar 13 freedom of movement for instantaneous activation by the owner.

Non-slip collars 11, 12 and slip collar 13, and all perpendicular elements 14, 15 and 16, as herein described can be made of, but not limited to, nylon, rope, leather, fabric, and core-wound cord. In the preferred embodiment, non-slip collars 11 and 12 are made of nylon, and slip collar 13 is made of core-wound cord. Adjustable elements 17 and 18 can be made of durable plastic, or metal. It should be appreciated that, although the connector elements 19 and 20 as shown can be made from the same material as the perpendicular elements, it is also possible that the loops can instead be made of a different material such as rope, metal, plastic or fabric which is appropriately connected to the perpendicular element using methods well known in the art.

In this embodiment, to put the collar on the animal, the buckles 17 and 18 are first opened by pulling up on the top of the snap-on buckle element. The collar can be placed over the head of the animal positioning non-slip collar 11 at the base of the animal's neck. The non-slip collar 11 is then tightened by threading its strap through the buckle 17. The perimeter of non-slip collar 11 is then fixed by pressing down firmly until a “snap” is heard, signifying that the buckle is fully closed. The process is repeated to adjust the fit and close the buckle for the non-slip collar 12, which will rest at the top of the animal's neck just below the slip collar 13. FIG. 2 shows that both non-slip collars 11 and 12 should fit snugly, but not tightly, and they hold slip collar 13 in position for control just below the animal's ears. Once non-slip collars 11 and 12 are fastened, the ends are slid through the keepers 23 and 24. Additional keepers can be used, in conjunction with keepers 23 and 24. As illustrated in FIG. 1, each of the non-slip collars 11 and 12 includes a keeper located proximal to each of the buckles 17 and 18. Perpendicular element 16 is movable and should be adjusted so that it rests towards the top of the neck of the animal as illustrated in FIG. 2, near buckles 17 and 18 that are preferably arranged centered over the animal's spine wherein perpendicular element 16 is equidistant to the buckles 17 and 18 relative to the location of the perpendicular element 14 (e.g., spaced with respect to one another as illustrated in FIG. 1). Perpendicular element 15 is also movable and should be adjusted so that it centers at the throat of the animal. Perpendicular element 14, in this embodiment, is permanently stitched into place.

As illustrated in FIG. 2, the perpendicular element 15 is arranged at the front of the animal's neck, at the throat. Accordingly, perpendicular element 15 protects the animal's throat by correctly spacing the non-slip collars 11 and 12, preventing them from collapsing towards one another when the animal bends its neck. The perpendicular elements 14, 15, and 16 thereby provide proper alignment of the non-slip collars 11 and 12, as well as the slip collar 13, which is maintained in position at the top of the animal's neck, directly behind its ears.

A leash 38 is attached to “O” ring 22 on slip collar 13. Pulling the leash will allow slip collar 13 to be tightened or loosened, thereby achieving control over the animal.

In an alternate embodiment, said collar incorporates a body of mesh netting or resilient fabric 39 which connects to (some) of the collars and perpendicular elements. This mesh 39 is available with differing types (stitched to self, or adjustably closed) of folded flaps 40 to adhere it to the collar. Mesh netting or resilient fabric 39 could be formed with every flap having an adjustable closure mechanism that would allow the mesh 39 to be completely removed from the collar, and then reapplied to the collar at a later date if the user desired.

The mesh netting or resilient fabric 39 allows the owner to establish fit parameters for the dog's neck, by loosely containing the lateral movement of the perpendicular elements when 39 fabric is installed onto the collar. Since mesh netting or a resilient fabric 39 can be used that can have 2-way, 4-way, or 8-way stretch capabilities, the mesh can conform to differing sizes of dogs neck by orienting itself laterally or longitudinally based on the fit of the collars around the dog's neck and the placement of the perpendiculars. The mesh netting or resilient fabric 39 can be manufactured to accommodate other embodiments of the collar, which might contain more than three collars, more than three perpendicular elements, and still allow for adjustability for fit, comfort and control.

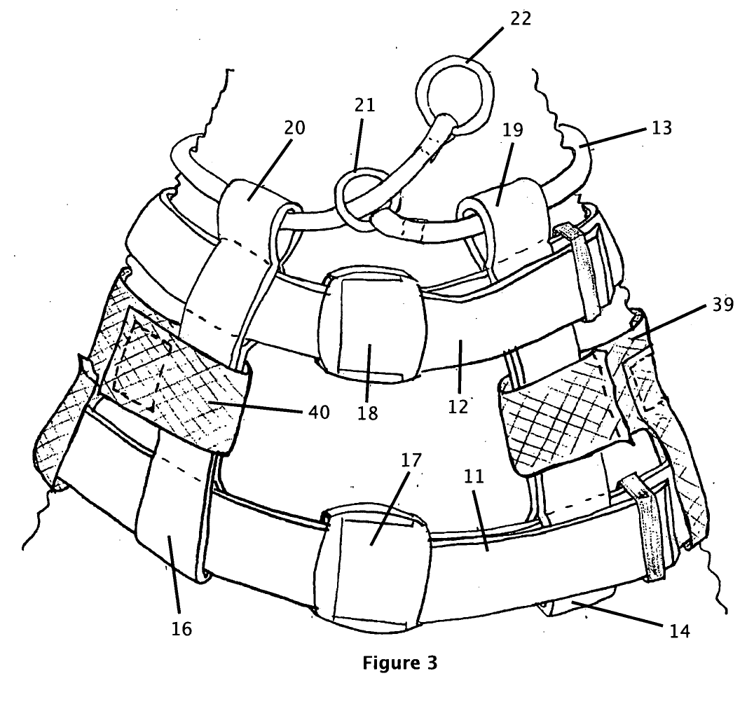

FIG. 3 is a view of the collar from above the animal's neck, shown with the removable resilient fabric or mesh netting 39. It is shown in a stitched form, but can also be adjustably closed. The mesh can also be connected to the collars at various other intervals or locations not shown.

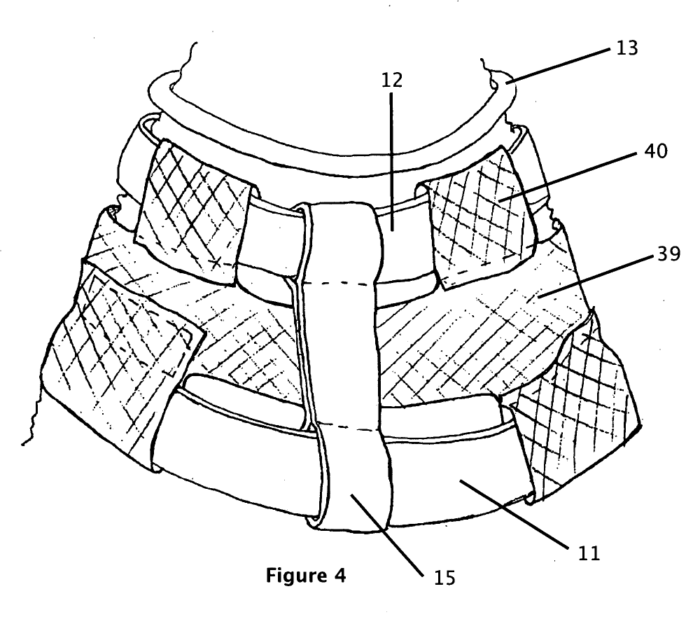

FIG. 4 is a view of the collar from beneath the animal's neck, shown with the removable resilient fabric or mesh netting. The mesh netting or resilient fabric is attached to the collars by loops which are secured in place, stitched to itself or with an adjustable hook and loop (or other) fasteners attaching to itself as an option. These looping attachments, whether fixed or adjustable, can be of varying widths or lengths while still allowing overall movement and adjustability of the main elements of the flat collars.

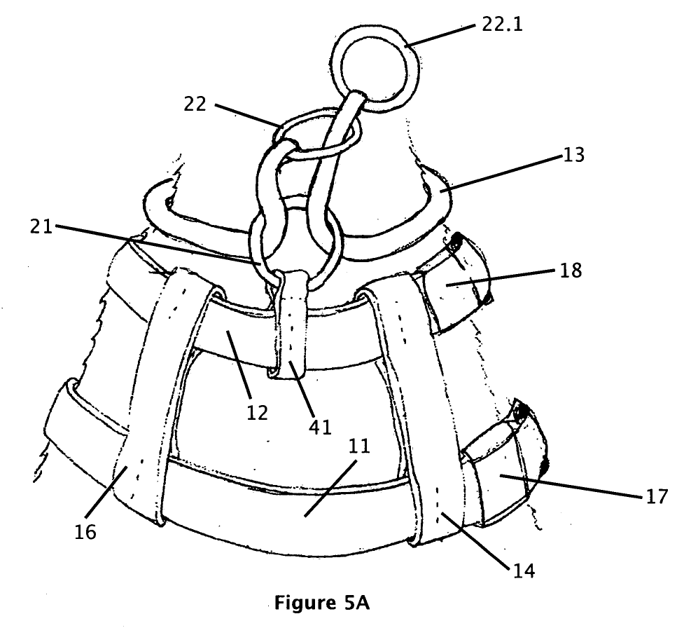

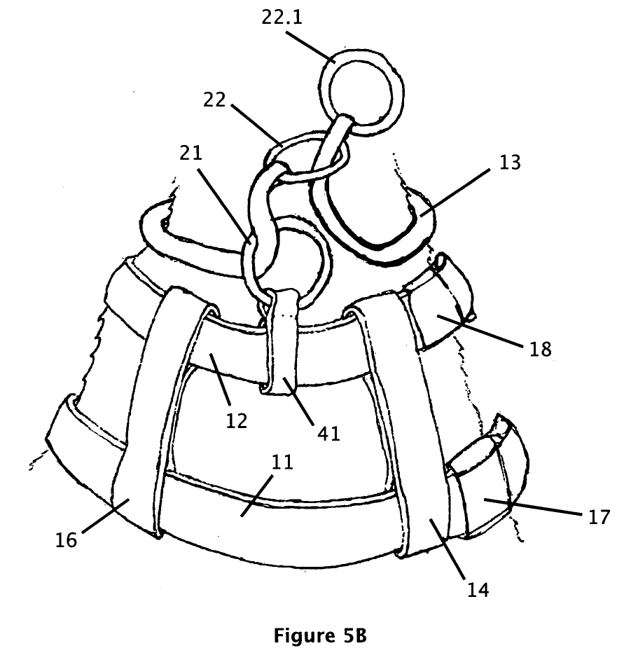

FIG. 5 is a side view of the collar, shown with more than 2 “O” rings. The advantage of having more than two “O” rings is that that slip collar can be rotated on the central “O” ring to be oriented to walk dog on either right or left prior to putting on dog. Also, the slip collar is non-removable and cannot be lost.

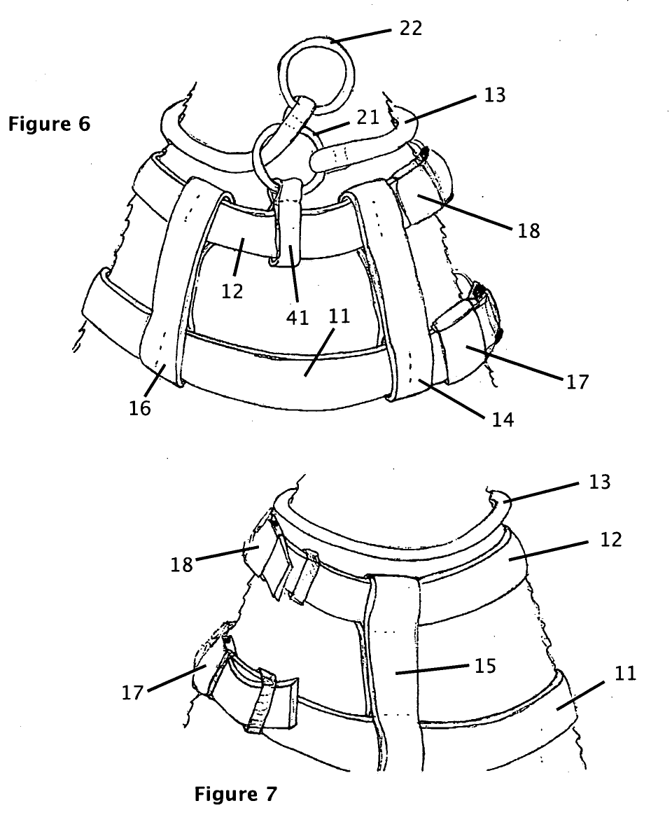

FIG. 6 is a top view of the collar, shown with the slip collar 13 not engaged to the perpendiculars. This requires modified shorter perpendiculars 14 and 16 without the extra self-loops 19 and 20. Buckles 18 and 17 are located to the side of the animal. Alternatively, the top “O” ring could be on the other side, allowing the pet owner to walk the dog from both sides.

FIG. 7 is a view of the collar in FIG. 6 from below the animal's neck. One perpendicular 15 is located on the underside. Buckles 18 and 17 are located to the side of the animal.

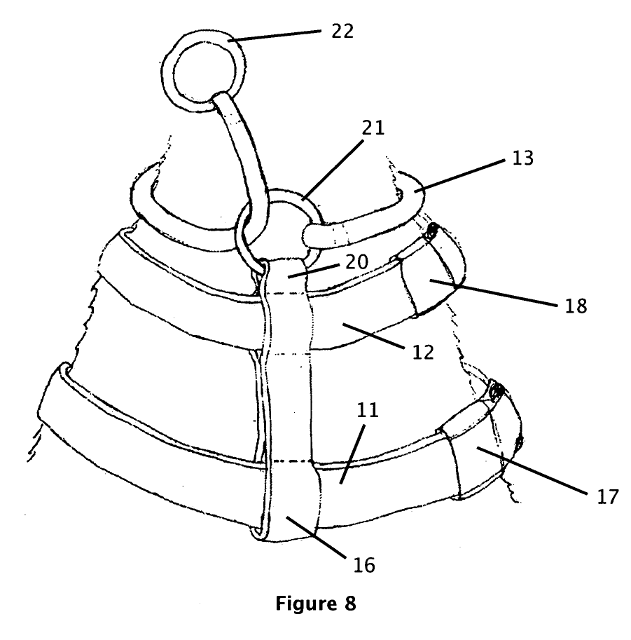

FIG. 8 is a top view of the collar, shown with one perpendicular 16 on top. Buckles 18 and 17 are located to the side of the animal. “O” rings 21 and 22 are located above perpendicular 16 and engaged with said perpendicular.

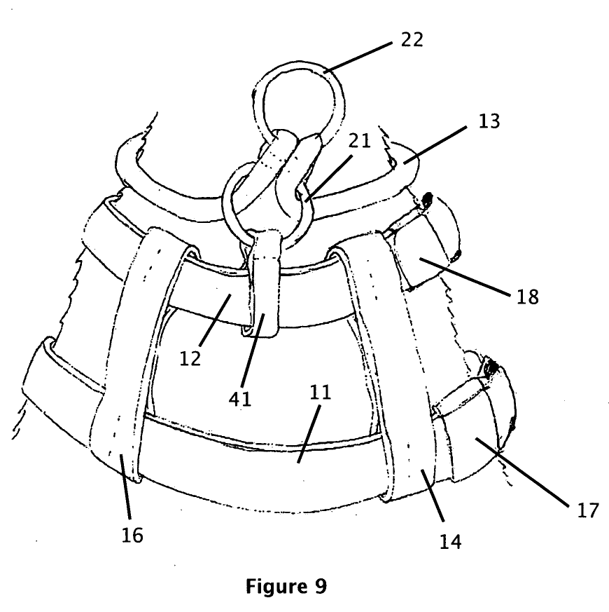

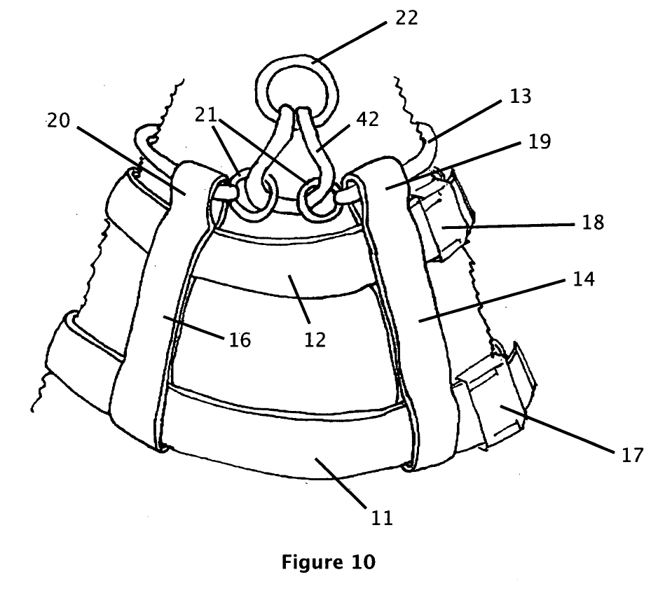

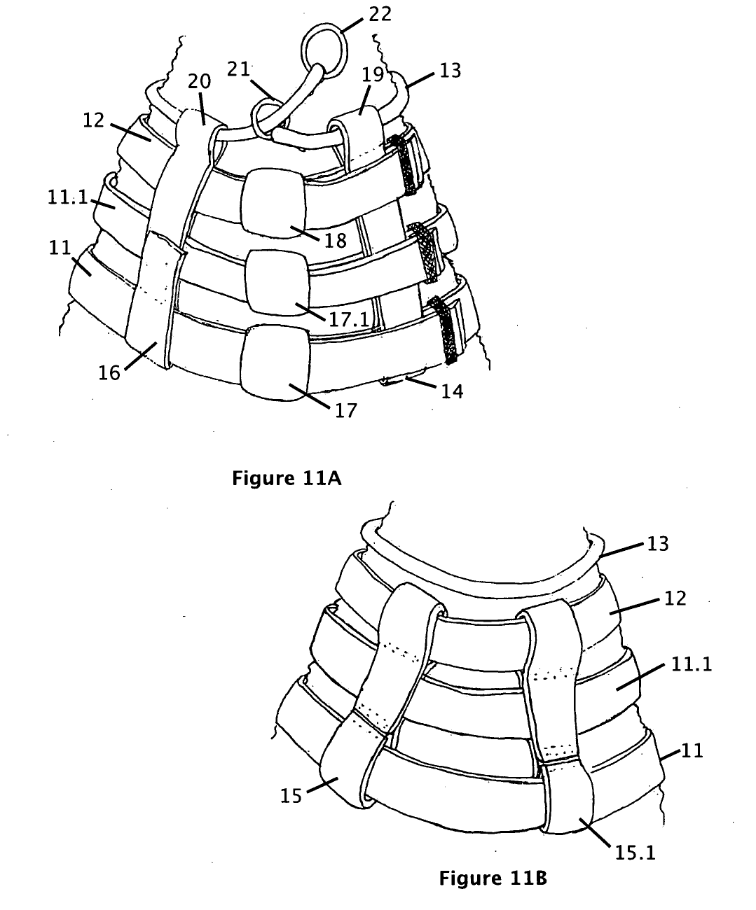

FIG. 9 is a top view of the collar, shown in an alternate embodiment wherein both of the slip collar's 13 ends are attached to one “O” 22 ring. “O” ring 21 is attached to the perpendicular 11. Buckles 18 and 17 are located to the side of the animal.

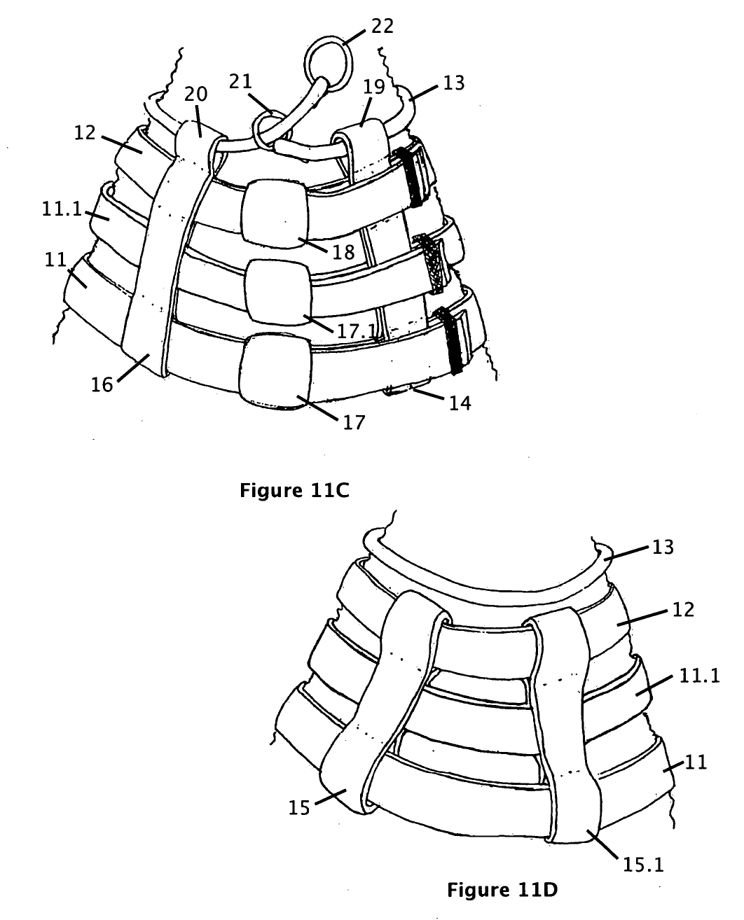

FIG. 10 is a top view of the collar, shown in the “Martingale style” with a third “O” ring 22. Slip collar 13 is engaged with perpendiculars 16 and 14. Two “O” rings 21 hold a slip collar loop. Collars 11 and 12 have buckles 17 and 18 on the side of the animal.

It should be understood that the invention has application far beyond the exemplary embodiments presented and described herein, and as such, is not to be limited strictly to those embodiments. In addition, the invention is not limited to the particular physical configuration, but instead is adaptable. All changes, modifications, variations, and other uses and applications which do not depart from the spirit and scope of the invention are deemed to be covered by the invention.

What is claimed is:

1. An apparatus for training animals comprising:
(a) at least three collars, wherein at least one of said collars is a slip collar and at least two of said collars are non-slip collars, and
(b) a plurality of perpendicular elements, running perpendicular to said collars, which are connected and link to said collars.

2. The apparatus of claim 1, wherein said perpendicular elements are connected to one another by an optionally removable resilient fabric looped around said perpendicular elements.

3. The apparatus of claim 1, wherein said perpendicular elements are connected to one another by an optionally removable, single or double-ply mesh net looped around said perpendicular elements.

4. The apparatus of claim 1, wherein said slip collar is adjusted by two “O” rings.

5. The apparatus of claim 1, wherein said slip collar is adjusted by three “O” rings.

6. The apparatus of claim 1, wherein the “O” rings are centrally located and permanently attached.

7. The apparatus of claim 1, wherein said perpendicular elements are longer or shorter depending on whether they are engaged to the slip collar or not.

8. The apparatus of claim 1, wherein there are more than three said perpendicular elements.

9. The apparatus of claim 8, wherein there are more than three said collars.

10. The apparatus of claim 1, wherein there are three said collars.

11. The apparatus of claim 10, wherein there are three said perpendicular elements.

12. The apparatus of claim 11, wherein at least one of the three perpendicular elements is adjustably connected to said collars.

13. The apparatus of claim 12, wherein two of said perpendicular elements are adjustably connected to said collars.

14. The apparatus of claim 1, wherein the collars and perpendicular elements are made of material selected from the group consisting of nylon, rope, leather, fabric, and core-wound cord.

15. The apparatus of claim 9, wherein at least one collar is made of core-wound cord.

16. The apparatus of claim 11, wherein two of the said collars have an adjustable element.

17. The apparatus of claim 16, wherein said adjustable element is a snap-on buckle.

18. The apparatus of claim 17, wherein said snap-on buckle is on the top or side of the animal.

19. An apparatus for training animals comprising:
(a) at least three collars, wherein at least one of said collars is a slip collar and at least two of said collars are non-slip collars, and
(b) a plurality of perpendicular elements, running perpendicular to said collars, which are connected and link to said collars,
wherein at least one of the perpendicular elements is adjustably connected to said collars,
wherein at least one of the collars is made of core-wound cord, and
wherein the other collars, not made of core-wound cord, have a snap-on buckle.

20. An apparatus for training animals comprising:
(a) at least three collars, wherein at least one of said collars is a slip collar and at least two of said collars are non-slip collars, and
(b) a plurality of perpendicular elements, running perpendicular to said collars, which are connected and link to said collars,
wherein there are three collars,
wherein there are three perpendicular elements,
wherein two of the three perpendicular elements is adjustably connected to said collars,
wherein one of the three collars is made of core-wound cord, and
wherein the other two collars, not made of core-wound cord, each have a snap-on buckle.
